(19) United States
(12) Patent Application Publication
(10) Pub. No.: US 2007/0216697 A1
(43) Pub. Date: Sep. 20, 2007

(54) Print Buffer Unit

(75) Inventors: Dai Tanaka, Nagano-ken (JP); Fumio Koyama, Nagano-ken (JP); Yoshiyuki Kodama, Nagano-ken (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 10/599,425

(22) PCT Filed: Mar. 29, 2005
(86) PCT No.: PCT/JP05/06587

§ 371 Date: Sep. 28, 2006

(30) Foreign Application Priority Data
Mar. 29, 2004 (JP) 2004-095622
Jan. 14, 2005 (JP) 2005-007147

(51) Int. Cl. G09G 5/36

(52) U.S. Cl. 345/545

(57) ABSTRACT

A print buffer unit temporally storing print data to be printed on a printer includes a data-storing section storing the print data, a print-image creating section creating a print image from the print data, and a print-image displaying section displaying the print image.

### TECHNICAL FIELD

The present invention relates to print buffer units temporally storing print data that are created by host apparatuses such as computers and that are to be printed on printers.

### BACKGROUND ART

Known print buffer units temporally storing print data to be printed on printers usually include input-output sections, storage sections, and controlling sections, and are of a desktop type driven with power for households. A print buffer unit described in Japanese Unexamined Utility Model Registration Application Publication No. 6-43745 can be moved while temporally storing print data therein by employing a portable power source.

However, the known print buffer units cannot display content of the print data temporally stored in the print buffer units. Therefore, when multiple pieces of print data are temporally stored in the print buffer units, or when the print buffer units are moved while temporally storing print data therein, users of the print buffer units must record information such as the print data temporally stored in the print buffer units if necessary to avoid wrong operations such as printing of other print data.

### DISCLOSURE OF INVENTION

To solve the above-described problems, it is an object of the present invention to provide a print buffer unit temporally storing print data to be printed on a printer, including a data-storing section storing the print data; a print-image creating section creating a print image from the print data; and a print-image displaying section displaying the print image.

According to the above-described structure, the print buffer unit displays the print image of the print data temporally stored therein on the print-image displaying section. Therefore, the user of the print buffer unit can ascertain the content of the print data temporally stored in the print buffer unit to avoid wrong operations.

It is preferable that the print buffer unit according to the present invention further include a print-data modifying section modifying the print data.

Furthermore, according to the print buffer unit of the present invention, the print-data modifying section preferably includes at least one of print-sequence changing means for changing the sequence of printing of the print data, print-data duplicating means for duplicating the print data, and print-data deleting means for deleting the print data.

According to the above-described structure, the print data temporally stored in the print buffer unit can be modified in the print buffer unit immediately before printing. Therefore, the print data can be efficiently modified.

According to the print buffer unit of the present invention, it is preferable that the print-data modifying section further include print-image modifying means for modifying the print image.

According to the above-described structure, the print image is created from the print data temporally stored in the print buffer unit, and the print image can be modified to be printed. Therefore, the print image can be modified in the print buffer unit while it is visually identified.

According to the print buffer unit of the present invention, the print-image displaying section is preferably capable of maintaining displayed content even after power supply is cut.

According to the above-described structure, the print-image displaying section of the print buffer unit maintains the displayed content without consuming power. Therefore, the electrical power consumption of the print buffer unit can be reduced.

According to the print buffer unit of the present invention, it is preferable that the print-image creating section create the print image split into at least two parts, and that the print-image displaying section merge the split parts of the print image into one and display the print image.

According to the above-described structure, since the print-image displaying section maintains the displayed content, memories required for display processing can be reduced by splitting the print image in the print-image creating section and by performing display processing by the split image to sequentially display the image in the print-image displaying section.

According to the print buffer unit of the present invention, the print buffer unit may be driven by a portable power source.

To solve the above-described problems, it is an object of the present invention to provide a print system including a print buffer unit, printable data being input to the print buffer unit; and a printer. The print system is characterized in that the print buffer unit creates a print image from the data and displays the print image; the print buffer unit sends the data to the printer, the data being modified so as to change the print image; and the printer prints on the basis of the data.

According to the above-described structure, the same effects functions and effects as in the above-described print buffer unit can be obtained.

### BRIEF DESCRIPTION OF THE DRAWINGS

The above-described objects and other objects, characteristics, and advantages of the present invention will easily become clearer from the following detailed descriptions of a preferred embodiment of the present invention described with reference to the attached drawings.

FIG. 1 is a schematic view illustrating an outline configuration of a print buffer unit according to an embodiment of the present invention.

FIG. 2 is a block diagram illustrating the principal hardware configuration of the print buffer unit.

FIG. 3 is a schematic block diagram illustrating functions of the print buffer unit.

FIG. 4 is a flow chart illustrating the functions of the print buffer unit in a printing operation.

FIG. 5 is a schematic view illustrating a displaying process on a display panel.

FIG. 6 is a schematic view illustrating a process of modifying a print image.

### BEST MODE FOR CARRYING OUT THE INVENTION

A print buffer unit according to an embodiment of the present invention will now be described with reference to the drawings.

### Embodiment

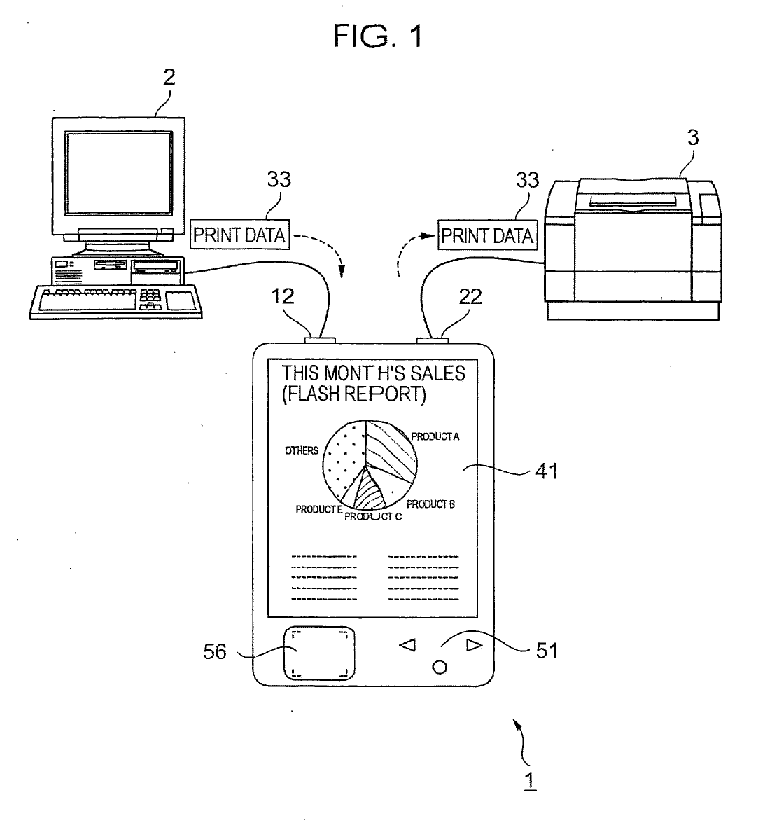

FIG. 1 is a schematic view illustrating an outline configuration of a print buffer unit 1 according to an embodiment of the present invention. As shown in FIG. 1, the print buffer unit 1 is connected to a host apparatus 2 and a printer 3. Print data 33 created by the host apparatus 2 is sent to the print buffer unit 1, processed in the print buffer unit 1, and then sent to the printer 3 to be printed.

The print buffer unit 1 includes a display panel 41, an operation switch 51, and a modification pad 56 on the top surface thereof. The print buffer unit 1 further includes a data-inputting port 12 and a data-outputting port 22 on a side surface thereof. The display panel 41 displays a print image to be printed on the printer 3. The operation switch 51 is an input device for a user that operates the print buffer unit 1. The modification pad 56 is a character-inputting device for a user that modifies the print image displayed on the display panel 41.

The data-inputting port 12 inputs the print data 33 created by the host apparatus 2 to the print buffer unit 1. On the other hand, the data-outputting port 22 outputs the print data 33 from the print buffer unit 1 to the printer 3. The connection between the data-inputting port 12 and a printer output port (not shown) of the host apparatus 2 and the connection between the data-outputting port 22 and a printer input port (not shown) of the printer 3 are established via USB (Universal Serial Bus). However, other connections such as an RS-232C connection, a parallel connection, and a network connection using 100 Base-T Standard may be employed.

Moreover, the host apparatus 2 is a personal computer having an operating system of Microsoft® Windows®. Also, other operating systems having printing functions may be employed. Furthermore, the printer 3 is a page printer controlled by a printer code called “ESC/PAGE” (a control code for page printers developed by Seiko Epson Corporation). However, other printers such as a page printer controlled by a printer code called “PostScript” (a page-description language developed by Adobe Systems Incorporated), and a printer capable of directly printing descriptive data written by document structure description languages such as XML and HTML may be employed.

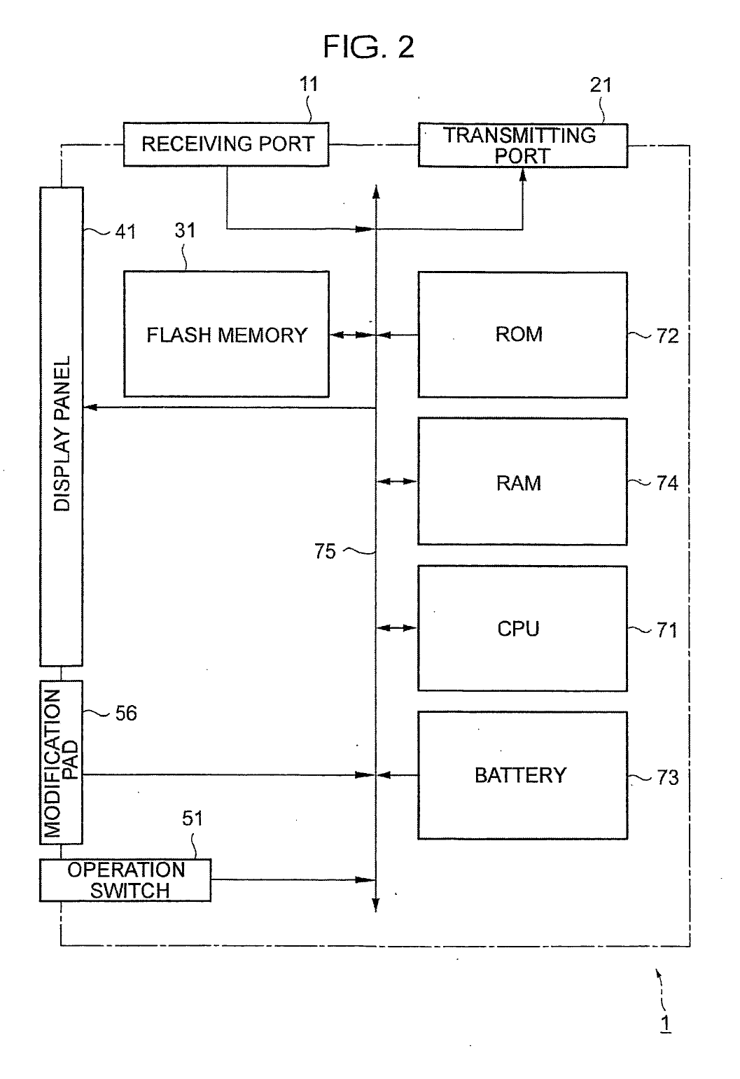

FIG. 2 is a block diagram illustrating the principal hardware configuration of the print buffer unit 1. As shown in FIG. 2, the print buffer unit 1 includes a CPU (Central Processing Unit) 71, a RAM (Random Access Memory) 74, a ROM (Read Only Memory) 72, a battery 73, a flash memory 31, the display panel 41, the modification pad 56, the operation switch 51, a receiving port 11, and a transmitting port 21. These components are connected to each other via a bus 75.

The CPU 71 reads various programs such as a primary control program and application programs and data stored in the RCM 72, loads the programs and the data into a working area provided in the RAM 74 to execute them, and controls the respective components of the print buffer unit 1.

The flash memory 31 is nonvolatile data-storing means having a large capacity for storing the print data 33 in response to instructions from the CPU 71.

The display panel 41 is a high-contrast display component of an electrophoretic type capable of maintaining displayed content.

The display component of the electrophoretic type will now be described in general without drawings. The display component of the electrophoretic type is produced by dying respective microcapsules in two colors and putting them between substrates of the display component having transparent electrodes. The microcapsules encapsulate organic or inorganic particles (electrophoretic particles) that migrate by electrophoresis due to potential differences. When a voltage is applied from the transparent elements to the produced display component, the electrophoretic particles accumulate at one side of the electrodes. Accordingly, the microcapsules gather in one direction. Therefore, an observer of the display component sees one color applied on the microcapsules. Moreover, when a reverse voltage is applied to the transparent elements, the microcapsules gather in the other direction. Accordingly, the observer of the display component sees the other color applied to the microcapsules. Furthermore, even when the applied voltage is removed, the alignment of the microcapsules by the voltage application is stably maintained in these aligning directions, and thus the displayed content on the display component is maintained.

Therefore, when a displaying signal and a driving voltage are supplied, the display component of the electrophoretic type displays in response to the displaying signal. Hereafter, the displayed content on the display component is maintained even when the displaying signal and the driving voltage are not provided.

The receiving port 11 and the transmitting port 21 are USB ports including interfaces. The operation switch 51 includes arrow keys, buttons, and the like. The modification pad 56 includes, for example, a touch panel capable of inputting handwritten characters. The battery 73 may be a portable power source such as an electric cell.

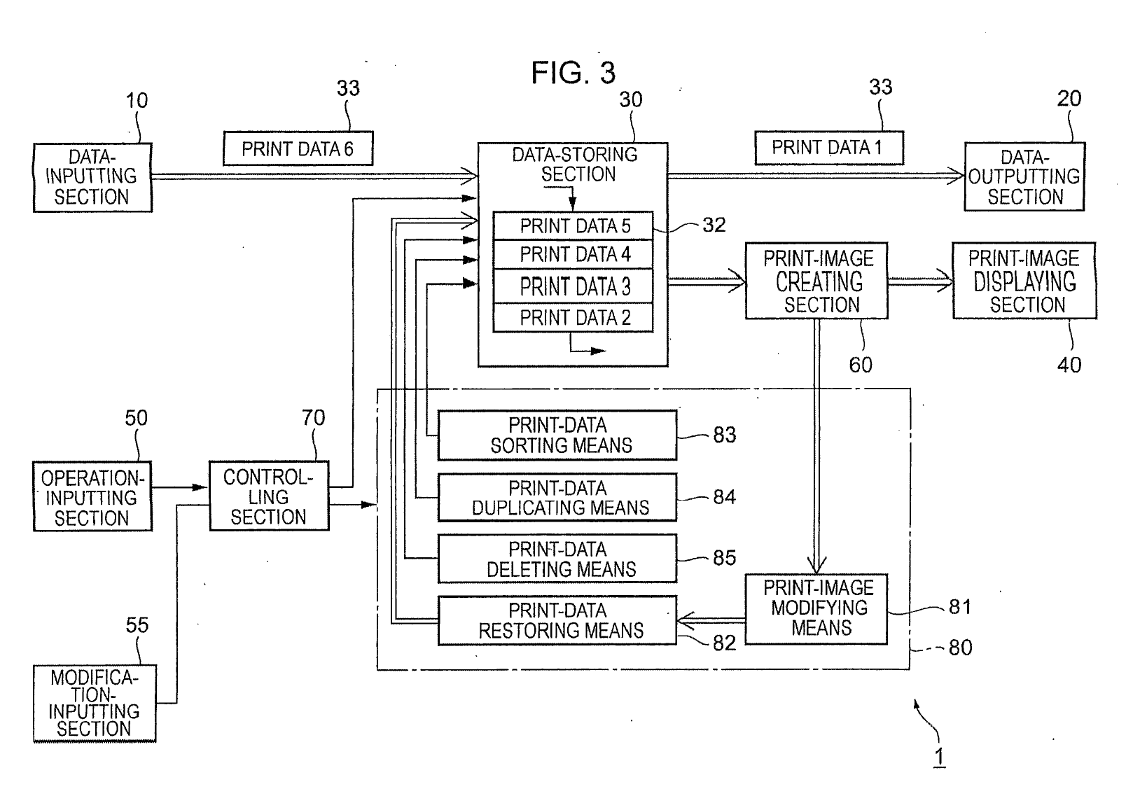

FIG. 3 is a schematic block diagram illustrating functions of the print buffer unit 1. This print buffer unit 1 includes an operation-inputting section 50, a controlling section 70, a data-inputting section 10, a data-storing section 30, a print-image creating section 60, a print-image displaying section 410, a modification-inputting section 55, a print-data modifying section 80, and a data-outputting section 20. The print-data modifying section 80 includes print-data sorting means 83, print-data duplicating means 84, print-data deleting means 85, print-image modifying means 81, and print-data restoring means 82.

The data-inputting section 10 is composed of hardware including the receiving port 11 and the data-inputting port 12. The data-inputting section 10 receives the print data 33 created in the host apparatus 2 and sent to the print buffer unit 1 via USB, and transfers the print data 33 to the data-storing section 30.

The operation-inputting section 50 is composed of hardware including the operation switch 51, and transmits operational instructions input by a user of the print buffer unit L to the controlling section 70. The user of the print buffer unit 1 can issue instructions for a startup of the print buffer unit 1, selection of the print data 33 to be printed on the printer 3, deletion of the print data 33, change in printing order, modification of the print image, printing, and the like from this operation-inputting section 50.

The controlling section 70 issues operational instructions to the respective functional sections in response to the instructions from the operation-inputting section 50. In addition, the controlling section 70 manages the responses from the respective functional sections to the instructions. The controlling section 70, the print-image creating section 60, and the print-data modifying section 80 are features implemented via hardware resources of the CPU 71, RAM 74, and the ROM 72 and software stored in the RCM 72 organically cooperated with each other r.

The data-storing section 30 is composed of hardware including the flash memory 31, and stores the print data 33. The amount of print data 33 that can be stored in the data-storing section 30 depends on the capacity of the flash memory 31 and the size of the print data 33. Moreover, the data-storing section 30 includes a data queue 32 storing the print data 33 in the order of input and outputting the print data 33 in the order of storage. The print data 33 stored in this data queue 32 can be sorted in the data queue 32 in response to the instructions from the controlling section 70. The printing order of the print data 33 is also changed according to the sorted order. Furthermore, the print data 33 in a print queue can be duplicated or deleted in response to the instructions from the controlling section 70.

The data-outputting section 20 is composed of hardware including the transmitting port 21 and the data-outputting port 22, and transfers the print data 33 sent from the data-storing section 30 to the printer 3 in response to the instruction for printing from the controlling section 70.

The print-image creating section 60 creates a print image to be printed on the printer 3 from the print data 33 stored in the data queue 32 of the data-storing section 30 in response to the instruction for displaying the print image from the controlling section 70. That is to say, the print-image creating section 60 interprets the printer code described in ESC/PAGE, and separates it into print-figure data to be printed on the printer 3 and control data controlling printing. The control data herein is data of information such as print directions and imaging magnifications. The print-image creating section 60 then loads the print-figure data into the memory in accordance with the control data to create the print-image data, and sends the print-image data to the print-image displaying section 40. The print-figure data and the control data controlling printing are also sent to the print-data modifying section 80 in response to the instructions from the controlling section 70.

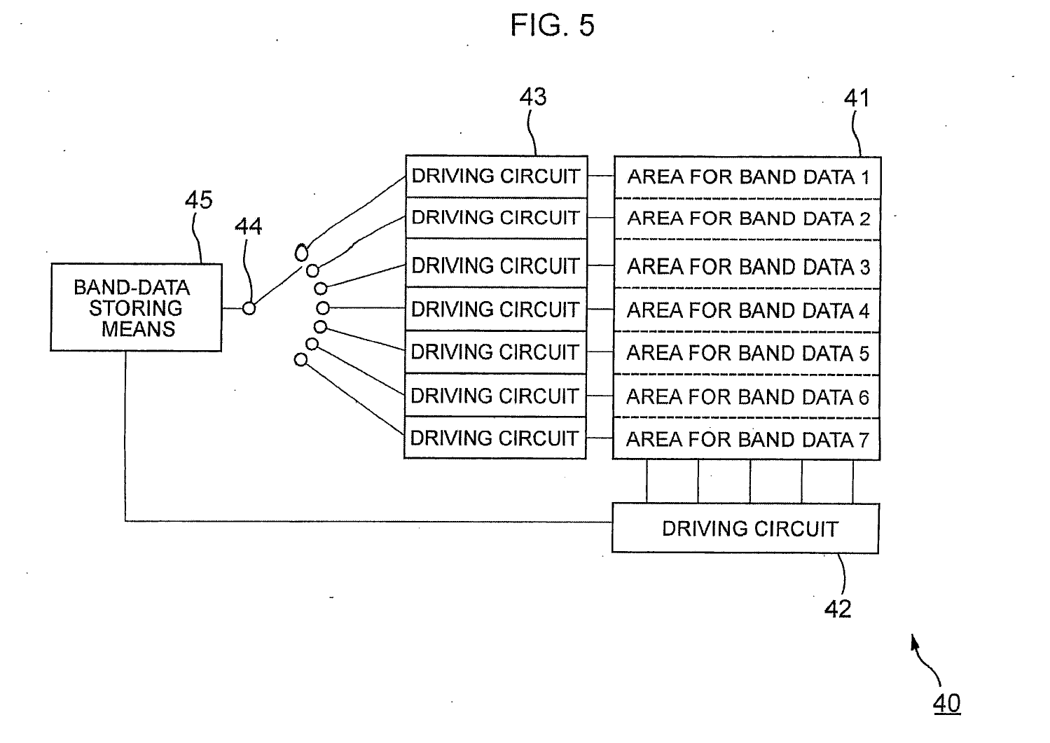

The print-image displaying section 40 is composed of hardware including the display panel 41, driving circuits of the display panel (42, 43), a selector switch 44, and band-data storing means 45 (FIG. 5). The print-image displaying section 40 receives the print-image data sent from the print-image creating section 60, and displays the print image on the electrophoretic display panel 41. The displaying process on the display panel 41 will be described later.

The modification-inputting section 55 is composed of hardware including the modification pad 56, and transmits instructions on modification of the print image to the print-image modifying means 81. The user of the print buffer unit 1 can issue instructions for modification of information for printing control such as print directions and imaging magnifications from this modification-inputting section 55.

The print-data duplicating means 84 duplicates the print data 33 in the data queue 32 into a desired position in the data queue 32 in response to the instruction from the operation-inputting section 50. Moreover, the print-data deleting means 85 deletes the print data 33 in the data queue 32 in response to the instruction from the operation-inputting section 50. Furthermore, the print-data sorting means 83 changes the sequence of printing by sorting the print data 33 in the data queue 32 in response to the instruction for changing the sequence of the print data 33 from the operation-inputting section 50. This data sorting can be performed by combining the functions of the print-data duplicating means 84 and the print-data deleting means 85.

The print-image modifying means 81 modifies the corresponding control data in response to the instruction for modifying the print image from the modification-inputting section 55. Moreover, the print-data restoring means 82 creates the print data 33 printable on the printer 3 from the modified control data and the print-figure data, and sends the print data 33 to the data-storing section 30. The detailed operations in the print-image modifying means 81 and the print-data restoring means 82 will be described later.

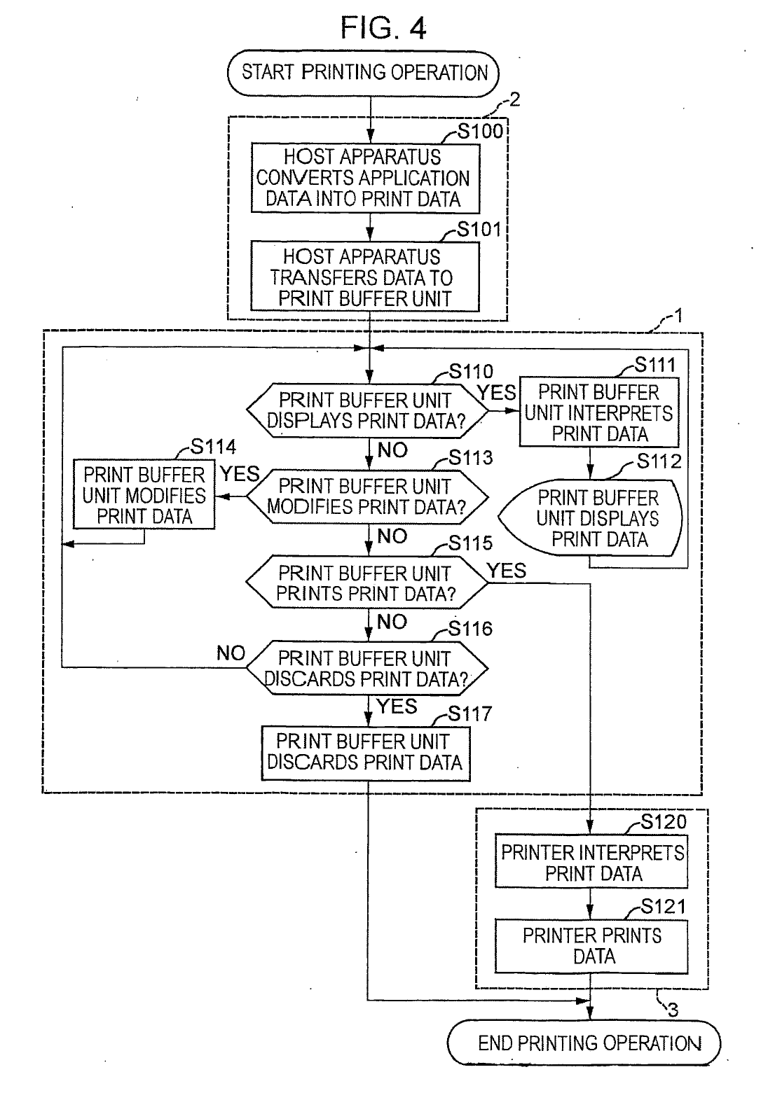

FIG. 4 is a flow chart illustrating the functions of the print buffer unit 1 in a printing operation. The functions of the print buffer unit 1 in the printing operation will be described with reference to FIGS. 4, 1, and 3.

First, the host apparatus 2 converts application data to be printed into the print data 33 (Step S100).

Next, the host apparatus 2 transfers the print data 33 to the print buffer unit 1 (Step S101).

The following processes are performed by the print buffer unit 1. At first, the print buffer unit 1 stores the transferred print data 33 in the data-storing section 30. Next, the print buffer unit 1 checks whether an instruction for displaying the print data 33 is issued from the operation-inputting section 50 (Step S110).

At this time, when the instruction for displaying the print data 33 is issued (YES in Step S110), the print buffer unit 1 interprets the print data 33 in the print-image creating section 60 to create a print image (Step S111).

Next, the print buffer unit 1 displays the print image in the print-image displaying section 40 (Step S112). After displaying the image, the print buffer unit 1 returns to the process of checking whether the instruction for displaying the print data 33 is issued from the operation-inputting section 50 (Step S110).

On the contrary, when the instruction for displaying the print data 33 is not issued (NO in Step S110), the print buffer unit 1 checks whether an instruction for modifying the print data 33 is issued from the modification-inputting section 55 (Step S113).

At this time, when the instruction for modifying the print data 33 is issued (YES in Step S113), the print buffer unit 1 modifies the print data in the print-image modifying means 81, creates the print data printable on the printer 3 in the print-data restoring means 82, and then stores the data in the data-storing section 30 (Step S114). After storing the data, the print buffer unit 1 returns to the process of checking whether the instruction for displaying the print data 33 is issued from the operation-inputting section 50 (Step S110).

On the contrary, when the instruction for modifying the print data 33 is not issued (NO in Step S113), the print buffer unit 1 checks whether an instruction for printing the paint data 33 is issued from the operation-inputting section 50 (Step S115).

At this time, when the instruction for printing the print data 33 is not issued (NO in Step S115), the print buffer unit 1 checks whether an instruction for discarding the print data 33 is issued from the operation-inputting section 50 (Step S116).

At this time, when the instruction for discarding the print data 33 is not issued (NO in Step S116), the print buffer unit 1 returns to the process of checking whether the instruction for displaying the print data 33 is issued from the operation-inputting section 50 (Step S110).

On the contrary, when the instruction for discarding the print data 33 is issued (YES in Step S116), the print buffer unit 1 deletes the print data 33 in the data queue 32 in the print-data deleting means 85, and ends the printing operation (Step S117).

In addition, when the instruction for printing the print data 33 is issued (YES in Step S115), the print buffer unit 1 transfers the print data 33 to the printer 3. The printer 3 interprets the transferred print data 33 (Step S120).

Next, the printer 3 prints the print data 33 on sheets of paper, and then the printing operation ends (Step S121).

FIG. 5 is a schematic view illustrating a displaying process on the display panel 41 in the print-image displaying section 40. The displaying field of the display panel 41 is split into seven areas from an area for band data 1 to an area for band data 7 with a specific width. First driving circuits 43 are composed of the same driving circuits each correspond to a band-data area. Moreover, a second driving circuit 42 drives electrodes common to all the band-data areas.

The selector switch 44 selects one off the driving circuits 43 corresponding to the split band-data areas. Thus, the selected driving circuit 43 is electrically connected to the band-data storing means 45. This band-data storing means 45 reads data to be displayed on the band area connected by the selector switch 44 from the data of the print image loaded by the print-image creating section 60, and generates a displaying signal on the basis of the read data. That is to say, when the band-data storing means 45 and the driving circuit 43 corresponding to the band data 1 are connected by the selector switch 44, the band-data storing means 45 generates a displaying signal displayed on the area for the band data 1 and transfers the signal to the driving circuits (42, 43). Information is then displayed on the area for the band data 1 in response to the transferred displaying signal.

Next, when the selector switch 44 shifts to connect the band-data storing means 45 with the driving circuit 43 corresponding to the area for the band data 2, the band-data storing means 45 generates a displaying signal displayed on the area for the band data 2 and transfers the signal to the driving circuits (42, 43). Information is then displayed on the area for the band data 2 in response to the transferred displaying signal. Since the display panel 41 is a display component of an electrophoretic type capable of maintaining displayed content, the information precedently displayed on the area for the band data 1 is maintained even when the displaying signal including the driving power is not provided. In the same manner, the displaying signals for all the band data (1 to 7) are transferred, and the print image loaded by the print-image creating section 60 is displayed on the whole field of the display panel 41.

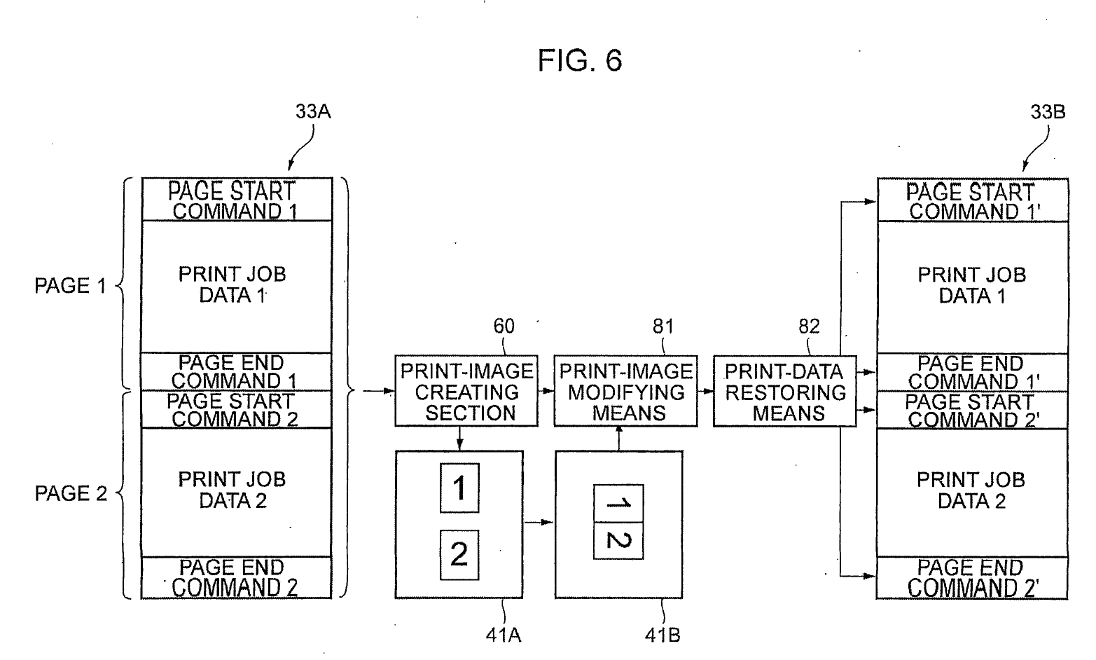

FIG. 6 is a schematic view illustrating a process of modifying a print image in the print-image modifying means 81 and the print-data restoring means 82.

Print data 33A stored in the data-storing section 30 is data for two pages. The print image created in the print-image creating section 60 is displayed on a display panel 41A. When a user of the print buffer unit 1 uses the print-image modifying means 81 to modify the print image as displayed on a display panel 41B, the image for two pages is rotated sideways and scaled down such that the image for two pages fits in a sheet for one page. The print-data restoring means 82 then restores print data 33B from this print image.

The print data 33 will now be described. This print data 33 is a printer code described in ESC/PAGE, and print information for one page is composed of print job data, i.e. the print-figure data, and print-controlling commands (Epson Job Language commands) arranged so as to put the print job data therebetween. The modification of the print image described above is made by modifying these print-controlling commands. Specifically, the following modifications are made to the controlling command for the first page.

(1) Supply a sheet.

(2) Scale the print figure down by 70%.

(3) Rotate the print figure rightward by 90°.

(4) Set the print-start position at an upper position of the sheet.

(5) Do not eject the sheet.

Furthermore, the following modifications are made to the controlling command for the next page.

(1) Do not supply a sheet.

(2) Scale the print figure down by 70%.

(3) Rotate the print figure rightward by 90°.

(4) Set the print-start position at a lower position of the sheet.

(5) Eject the sheet.

The print data 33B modified as above is sent to the data-storing section 30, and is replaced with the print data 33A. When receiving this data, the print-image creating section 60 creates a print image from the print data 33B to display the image in the print-image displaying section 40 (the display panel 41B). At this time, if the user of the print buffer unit 1 issues an instruction for printing the displayed print image, the print data 33B is transferred from the data-outputting section 20 to the printer 3, and the print image is printed as displayed on the display panel 41B.

According to the above-described embodiment, the following effects can be achieved.

(1) The print buffer unit 1 includes the data-storing section 30 for storing the print data 33, and is driven by a battery. Accordingly, the user of the print buffer unit 1 can carry the print buffer unit 1 storing the print data 33, and can print the print data 33 also at any place where he/she is by connecting the print buffer unit 1 with a compatible printer.

(2) The user of the print buffer unit 1 can delete the print data 33 stored in the print buffer unit 1 before printing. Accordingly, even if the user wrongly creates the print data 33 in the host apparatus 2, he/she can cancel printing to avoid wasting sheets of print paper.

(3) The user of the print buffer unit 1 can change the printing sequence of multiple pieces of print data 33 stored in the print buffer unit 1. Accordingly, the multiple pieces of print data 33 can be efficiently printed.

(4) The user of the print buffer unit 1 can modify the print-controlling commands in the print-image modifying means 81. Accordingly, even when the print buffer unit 1 is connected to a printer having different print specifications, the user can print by modifying the print-controlling commands.

Although the print buffer unit according to the present invention was described with reference to the drawings of the embodiment as above, the present invention is not limited to the embodiment. The display panel 41 is not limited to a display component of an electrophoretic type, but may be a display component such as a cholesteric liquid crystal having a maintaining characteristic. Moreover, the battery 73 may be a rechargeable battery, and may be recharged by receiving power from the host apparatus 2 or the printer 3 connected via USB.

Furthermore, the print-image modifying means 81 may include software (printer drivers) creating the print data 33 in the host apparatus 2, and may modify the print-figure data (print job data) of the print data 33.

In addition, the print buffer unit 1 may be integrated with the printer 3, and may function as a buffer unit with which the user can visually identify and modify the print image to be printed by this printer 3 before printing.

1. A print buffer unit temporally storing print data to be printed on a printer, comprising:
a data-storing section storing the print data;
a print-image creating section creating a print image from the print data; and
a print-image displaying section displaying the print image.

2. The print buffer unit according to claim 1, further comprising:
a print-data modifying section modifying the print data.

3. The print buffer unit according to claim 2, wherein the print-data modifying section comprises at least one of print-sequence changing means for changing the sequence of printing of the print data, print-data duplicating means for duplicating the print data, and print-data deleting means for deleting the print data.

4. The print buffer unit according to claim 2, wherein
the print-data modifying section comprises print-image modifying means for modifying the print image.

5. The print buffer unit according to claim 3, wherein
the print-data modifying section further comprises print-image modifying means for modifying the print image.

6. The print buffer unit according to claim 1, wherein
the print-image displaying section is capable of maintaining displayed content even after power supply is cut.

7. The print buffer unit according to claim 2, wherein
the print-image displaying section is capable of maintaining displayed content even after power supply is cut.

8. The print buffer unit according to claim 3, wherein
the print-image displaying section is capable of maintaining displayed content even after power supply is cut.

9. The print buffer unit according to claim 4, wherein
the print-image displaying section is capable of maintaining displayed content even after power supply is cut.

10. The print buffer unit according to claim 5, wherein
the print-image displaying section is capable of maintaining displayed content even after power supply is cut.

11. The print buffer unit according to claim 1, wherein
the print-image creating section creates the print image split into at least two parts; and
the print-image displaying section merges the split parts of the print image into one and displays the print image.

12. The print buffer unit according to claim 10, wherein
the print-image creating section creates the print image split into at least two parts; and
the print-image displaying section merges the split parts of the print image into one and displays the print image.

13. The print buffer unit according to claim 1, wherein
the print buffer unit is driven by a portable power source.

14. The print buffer unit according to claim 12, wherein
the print buffer unit is driven by a portable power source.

15. A print system comprising:
a print buffer unit, printable data being input to the print buffer unit; and
a printer, wherein
the print buffer unit creates a print image from the data and displays the print image;
the print buffer unit sends the data to the printer, the data being modified so as to change the print image; and
the printer prints on the basis of the data.
